(19) United States
(12) Patent Application Publication
(10) Pub. No.: US 2024/0020585 A1
(43) Pub. Date: Jan. 18, 2024

(54) INFORMATION PROCESSING APPARATUS, INFORMATION PROCESSING METHOD, AND NON-TRANSITORY STORAGE MEDIUM STORING PROGRAM

(71) Applicant: TOYOTA JIDOSHA KABUSHIKI KAISHA, Toyota-shi (JP)

(72) Inventors: Yoshikazu JIKUHARA, Miyoshi-shi (JP); Yoshinori KANEMITSU, Tachikawa-shi (JP); Yurika TANAKA, Yokosuka-shi (JP); Keiichi UNO, Chita-gun (JP)

(73) Assignee: TOYOTA JIDOSHA KABUSHIKI KAISHA, Toyota-shi (JP)

(21) Appl. No.: 18/198,466

(22) Filed: May 17, 2023

(30) Foreign Application Priority Data
Jul. 12, 2022 (JP) 2022-111795

(51) Int. Cl. G06Q 10/02; G06Q 50/30

(52) U.S. Cl. CPC G06Q 10/02; G06Q 50/30

(57) ABSTRACT

A controller is provided that designates a first position where a shielding object is present as a boarding point of a bus in response to a weather forecast at a boarding date and time of a user on the bus being predetermined weather.

### CROSS REFERENCE TO THE RELATED APPLICATION

This application claims the benefit of Japanese Patent Application No. 2022-111795, filed on Jul. 12, 2022, which is hereby incorporated by reference herein in its entirety.

### BACKGROUND

### Technical Field

The present disclosure relates to an information processing apparatus, an information processing method, and a non-transitory storage medium storing a program.

### Description of the Related Art

In an on-demand service, there is known a technology for delivering a position of a vehicle, a distance to a boarding/alighting place, and an estimated arrival time to a terminal of a user (for example, see Patent Literature 1).

### CITATION LIST

### Patent Literature

Patent Literature 1: Japanese Patent Application Laid-Open Publication No. 2020-98650

### SUMMARY

When it is raining or snowing, if the user is waiting for the bus at the boarding position of the bus, the user may get wet. The object of the present disclosure is to prevent the user from being affected by weather while waiting for a demand-type bus.

One aspect of the present disclosure is directed to an information processing apparatus including a controller configured to designate a first position where a shielding object is present as a boarding point of a bus in response to a weather forecast at a boarding date and time of a user on the bus being predetermined weather.

Another aspect of the present disclosure is directed to an information processing method for causing a computer to designate a first position where a shielding object is present as a boarding point of a bus in response to a weather forecast at a boarding date and time of a user on the bus being predetermined weather.

A further aspect of the present disclosure is directed to a non-transitory storage medium storing a program configured to cause a computer to designate a first position where a shielding object is present as a boarding point of a bus in response to a weather forecast at a boarding date and time of a user on the bus being predetermined weather.

Another aspect of the present disclosure is the above-described program.

According to the present disclosure, it is possible to prevent a user from being affected by weather while waiting for a demand-type bus.

### BRIEF DESCRIPTION OF THE DRAWINGS

FIG. 1 is a diagram illustrating a schematic configuration of a system according to the first embodiment.

FIG. 2 is a block diagram schematically illustrating an example of a configuration of each of a movement sign, a user terminal, a server, a bus, a store terminal, and a weather forecast server that constitute the system according to the embodiment.

FIG. 3 is a diagram illustrating a functional configuration of the server.

FIG. 4 is a diagram illustrating a table configuration of the user information DB.

FIG. 5 is a diagram illustrating a table configuration of the stop position information DB.

FIG. 6 is a diagram illustrating a table configuration of the bus information DB.

FIG. 7 is a diagram illustrating a table configuration of the movement sign information DB.

FIG. 8 is a diagram illustrating a functional configuration of the movement sign.

FIG. 9 is a diagram illustrating a functional configuration of the user terminal.

FIG. 10 is a flowchart of a process of generating an operation command for a movement sign and a bus in the server according to the first embodiment.

FIG. 11 is a diagram illustrating a relationship between weather and equipment stored in an auxiliary storage unit.

FIG. 12 is a flowchart of a process of generating operation commands for a movement sign and a bus in the server according to the second embodiment.

FIG. 13 is a flowchart of a process of generating an operation command for a movement sign and a bus in the server according to the third embodiment.

FIG. 14 is a diagram illustrating a table configuration of the stop position information DB according to the third embodiment.

FIG. 15 is a flowchart of a process of generating an operation command for a movement sign and a bus in the server according to the fourth embodiment.

FIG. 16 is a flowchart of a process of generating an operation command for a movement sign and a bus in the server according to the fifth embodiment.

### DESCRIPTION OF THE EMBODIMENTS

An information processing apparatus according to an aspect of the present disclosure includes a controller. The controller designates a first position where a shielding object is present as a boarding point of a bus in response to a weather forecast at a boarding date and time of the bus of a user being a predetermined weather. The bus is, for example, a demand-type bus (on-demand bus). In an on-demand bus, there may be no permanent sign at the bus stop and the location of the bus stop can be changed. The boarding date and time is acquired from, for example, a terminal of the user.

Here, when the user is waiting for the bus, the user may be disadvantaged or uncomfortable depending on the weather. For example, if it is raining or snowing, a user waiting for a bus may get wet. In addition, when the temperature is high or low, the user needs to endure heat or cold, and thus the user may feel uncomfortable. Similarly, on a windy day, the user may feel uncomfortable. On the other hand, in response to the weather forecast being the predetermined weather, the controller designates the first position where the shielding object is present as the boarding point of the bus.

The weather forecast may be a weather forecast for a time period during which the user desires to ride the bus. The weather forecast may be obtained, for example, from a server that provides the weather forecast. According to the weather forecast, it is possible to obtain information such as whether it is raining or snowing, whether it is not cold, whether it is not hot, and whether it is not windy while the user is waiting for the bus. The predetermined weather is, for example, weather that may cause a disadvantage to the user or weather that may cause discomfort to the user.

The shield may be a roof or a wall. In such a location, it is possible to prevent the user from getting wet due to rain or snow or being exposed to wind while waiting for the bus. In addition, in a place where cooling equipment or heating equipment is provided, it is possible to prevent a user from feeling uncomfortable if the place is surrounded by a shield. The first position may be, for example, a position at which a store is present. In this case, a road in front of the store or a parking lot of the store may be used as the bus stop. Then, since the user can wait for the bus in the store, the user is hardly affected by the weather while waiting. Further, since the number of customers can be increased on the store side, profits can be increased. In addition, for example, the bus operating company can increase profits by receiving a reward for guiding the user to the store from the store.

A mobile body that moves in accordance with an operation command received from the controller may be dispatched to the first position. The mobile body includes a display device that indicates that it is a bus stop, and arrives at the first position before the bus arrives to indicate that it is the bus stop. Here, in a demand-type bus, there is a case where there is no permanent sign at the bus stop, and there is a case where it is not recognized at a glance that the point is the bus stop. Therefore, there is a possibility that the user using the bus may not know where to wait. Therefore, it is conceivable to dispatch a mobile bus stop. By using this bus stop, it is possible to display that it is the bus stop at a point used as a bus stop. Therefore, the user can recognize the stop point of the bus by causing the display device to arrive earlier than the arrival time of the bus. On the other hand, in a case where the store is used as the bus stop, if the user is notified of the position of the store, the user can wait for the bus with the store as a mark, and thus the sign is not necessarily required.

Hereinafter, embodiments of the present disclosure will be described based on the accompanying drawings. The configurations of the following embodiments are examples, and the present disclosure is not limited to the configurations of the embodiments. In addition, the following embodiments can be combined with one another as long as such combinations are possible and appropriate.

### First Embodiment

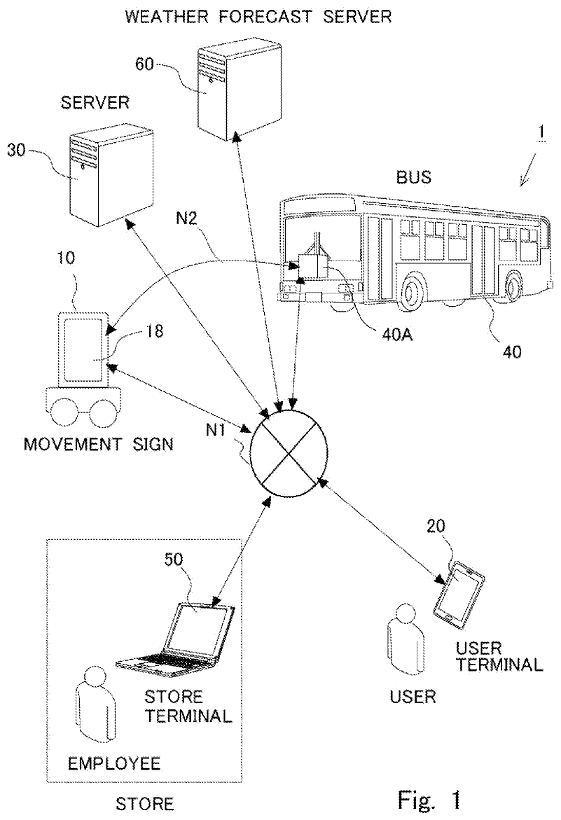

FIG. 1 is a diagram illustrating a schematic configuration of a system 1 according to an embodiment. In the system 1, when a server 30 receives a use request of a bus 40 from a user terminal 20, the server 30 generates a route of the bus 40 so that the user can use the bus 40, and the server 30 dispatches a movement sign 10 to a stop point of the bus The server 30 changes the dispatch destination of the movement sign according to the weather. That is, the stop point of the bus 40 is changed according to the weather. Therefore, the server 30 generates the route of the bus 40 according to the weather. Further, the server 30 transmits information on the stop position of the bus 40 to the user terminal. In the following description, the stop point of the bus 40 indicates a boarding point at which the user boards the bus 40 or an alighting point at which the user alights from the bus 40.

The user can reserve the bus 40 by transmitting a use request to the server 30 via the user terminal 20. The use request is information for the user to use the bus 40. The use request includes information related to a boarding point at which the user boards the bus 40, a boarding date and time at which the user boards the bus 40, and the alighting point at which the user drops off the bus 40. These are a boarding point desired by the user, a boarding date and time desired by the user, and an alighting point desired by the user. For example, the user can transmit the use request to the server 30 by executing predetermined application software installed in the user terminal 20.

The bus 40 is a vehicle in demand-type traffic that is operated in accordance with a user's reservation. Bus 40 is, for example, a vehicle driven by a driver, but may alternatively be a vehicle capable of autonomous travel. For autonomous traveling of the bus 40, a known technique can be used. The bus 40 travels on a route including a boarding point and an alighting point of the user. This route may vary depending on the boarding point and alighting points of other users. The initial position of the bus stop may be determined in advance. Then, a bus stop to be passed through may be selected according to the reservation. The position of the bus stop may be determined in accordance with the weather. The position of the bus stop and the route of the bus 40 may be determined by the server 30, for example. The bus 40 is not limited to a large vehicle, and may be a small passenger car or the like.

The movement sign 10 has, for example, a configuration of an electric vehicle, and travels by operating a motor with electric power stored in a battery. In addition, the movement sign 10 can autonomously travel. A known technique can be used for autonomous traveling of the movement sign 10. The movement sign 10 has, for example, a display 18. By displaying an image indicating a bus stop on the display 18, the user can be informed of the position of the bus stop. The server 30 generates a command for moving the movement sign 10 based on the stop point of the bus 40 and the stop time. For example, the server 30 manages the operation of the movement sign 10 so that the movement sign 10 arrives at the point where the user gets on the bus 40 a predetermined time before the time reserved by the user.

The server 30 is a device that manages the movement sign 10 and the bus 40.

When the server 30 receives a use request of the bus 40 from the user terminal 20, the server 30 determines the movement sign 10 and the bus 40 to be dispatched to the boarding point of the user, generates an operation command for the movement sign 10 and the bus 40, and transmits the operation command to the movement sign 10 and the bus

A weather forecast server 60 is a server that provides a weather forecast to the server 30. The store terminal 50 is a terminal used by an employee of a store existing around a point at which the bus 40 stops.

The movement sign 10, the user terminal 20, the server 30, the bus the store terminal 50, and the weather forecast server 60 are connected to each other by a network N1. The network N1 is, for example, a worldwide public communication network such as the Internet, and a wide area network (WAN) or other communication networks may be employed. In addition, the network N1 may include a telephone communication network such as a cellular phone or a wireless communication network such as Wi-Fi (registered trademark).

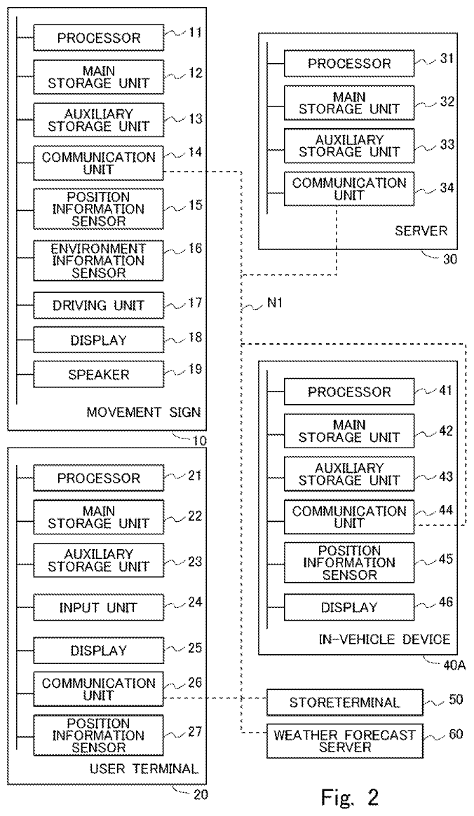

Hardware configurations of the movement sign 10, the user terminal 20, the server 30, and the in-vehicle device 40A of the bus 40 will be described based on FIG. 2. FIG. 2 is a block diagram schematically illustrating an example of a configuration of each of the movement sign 10, the user terminal 20, the server 30, the bus 40, the store terminal 50, and the weather forecast server 60 constituting the system 1 according to the present embodiment.

The server 30 has a configuration of a computer. The server 30 includes a processor 31, a main storage unit 32, an auxiliary storage unit 33, and a communication unit 34. These components are connected to each other by a bus. The processor 31 is an example of a controller.

The processor 31 is a central processing unit (CPU), a digital signal processor (DSP), or the like. The processor 31 controls the server 30 and performs calculation of various information processing. The main storage unit 32 is a random access memory (RAM), a read only memory (ROM), or the like. The auxiliary storage unit 33 is an erasable programmable ROM (EPROM), a hard disk drive (HDD), a removable medium, or the like. The auxiliary storage unit 33 stores an operating system (OS), various programs, various tables, and the like. The processor 31 loads the program stored in the auxiliary storage unit 33 into the work area of the main storage unit 32 and executes the program, and each component or the like is controlled through the execution of the program. As a result, the server 30 realizes a function matching a predetermined purpose. The main storage unit 32 and the auxiliary storage unit 33 are computer readable recording media. Note that the server 30 may be a single computer, or may be a combination of a plurality of computers. The information stored in the auxiliary storage unit 33 may be stored in the main storage unit 32. The information stored in the main storage unit 32 may be stored in the auxiliary storage unit 33.

The communication unit 34 is means for communicating with the movement sign 10, the user terminal 20, the bus 40, the store terminal 50, and the weather forecast server 60 via the network N1. The communication unit 34 is, for example, a local area network (LAN) interface board or a wireless communication circuit for wireless communication. The LAN-interface board and the wireless communication circuit are connected to the network N1. Since the configuration of the weather forecast server 60 is the same as that of the server 30, description thereof will be omitted.

Next, the movement sign 10 is, for example, a mobile body capable of traveling autonomously, and has a configuration of a computer. The movement sign 10 includes a processor 11, a main storage unit 12, an auxiliary storage unit 13, a communication unit 14, a position information sensor 15, an environment information sensor 16, a driving unit 17, a display 18, and a speaker 19. These components are connected to each other by a bus. The processor 11, the main storage unit 12, and the auxiliary storage unit 13 are the same as the processor 31, the main storage unit 32, and the auxiliary storage unit 33 of the server 30, description thereof will be omitted.

The communication unit 14 is a communication means for connecting the movement sign 10 to the network N1. The communication unit 14 is a circuit for communicating with another device (e.g., the server 30, bus 40 or the like) via the network N1 by making use of a mobile communication service (e.g., a telephone communication network such as 6G (6th Generation), 5G (5th Generation), 4G (4th Generation), 3G (3rd Generation), LTE (Long Term Evolution) or the like), Vehicle to Vehicle (V2V) communication network, and/or a wireless communication network such as Wi-Fi (registered trademark), Bluetooth (registered trademark) Low Energy, NFC (Near Field Communication), UWB (Ultra Wideband) or the like.

The position information sensor 15 acquires position information (for example, latitude and longitude) of the movement sign 10 at a predetermined cycle. The position information sensor 15 is, for example, a global positioning system (GPS) receiver, a wireless communication unit, or the like. The information acquired by the position information sensor 15 is stored in, for example, the auxiliary storage unit 13 or the like and transmitted to the server 30.

The environment information sensor 16 is means for sensing the state of the movement sign 10 or sensing the surroundings of the movement sign 10. As a sensor for sensing the state of the movement sign a gyro sensor, an acceleration sensor, or an azimuth sensor may be used. Examples of a sensor for sensing the surroundings of the movement sign 10 include a stereo camera, a laser scanner, a LIDAR, and a radar.

The driving unit 17 is a device for causing the movement sign 10 to travel based on the control command generated by the processor 11. The driving unit 17 is configured to include, for example, a plurality of motors for driving wheels included in the movement sign 10, and autonomous traveling of the movement sign 10 is realized by operating the plurality of motors in accordance with the control command.

The display 18 is means for presenting information to a user, and includes, for example, a liquid crystal display (LCD), an electroluminescence (EL) panel, or the like. The speaker 19 is a means for outputting voice, warning sound, or the like.

Next, the user terminal 20 will be described. The user terminal 20 is, for example, a small computer such as a smartphone, a mobile phone, a tablet terminal, a personal information terminal, a wearable computer (such as a smart watch), or a personal computer (PC). The user terminal includes a processor 21, a main storage unit 22, an auxiliary storage unit 23, an input unit 24, a display 25, a communication unit 26, and a position information sensor 27. These components are connected to each other by a bus. Since the processor 21, the main storage unit 22, and the auxiliary storage unit 23 are the same as the processor 31, the main storage unit 32, and the auxiliary storage unit 33 of the server 30, description thereof will be omitted. Further, since the position information sensor 27 is the same as the position information sensor 15 of the movement sign 10, description thereof is omitted.

The input unit 24 is means for receiving an input operation performed by a user, and is, for example, a touch panel, a mouse, a keyboard, a push button, or the like. The display 25 is means for presenting information to a user, and is, for example, a liquid crystal display (LCD), an electroluminescence (EL) panel, or the like. The input unit 24 and the display 25 may be configured as one touch panel display.

The communication unit 26 is a communication means for connecting to the network N1, and is a circuit for communicating with another device (e.g., the server 30 or the like) via the network N1 by making use of a mobile communication service (e.g., a telephone communication network such as 6G (6th Generation), 5G (5th Generation), 4G (4th Generation), 3G (3rd Generation), LTE (Long Term Evolution) or the like), and/or a wireless communication network such as Wi-Fi (registered trademark), Bluetooth (registered trademark) Low Energy, NFC (Near Field Communication), UWB (Ultra Wideband) or the like. Since the configuration of the store terminal 50 is the same as that of the user terminal 20, description thereof will be omitted.

Next, the bus 40 includes an in-vehicle device 40A. The in-vehicle device 40A has a configuration of a computer. The in-vehicle device 40A of the bus 40 includes a processor 41, a main storage unit 42, an auxiliary storage unit 43, a communication unit 44, a position information sensor and a display 46. These components are connected to each other by a bus. The processor 41, the main storage unit 42, and the auxiliary storage unit 43 are the same as the processor 31, the main storage unit 32, and the auxiliary storage unit 33 of the server 30, description thereof will be omitted. Further, since the communication unit 44 and the position information sensor 45 are the same as the communication unit 14 and the position information sensor 15 of the movement sign 10, description thereof is omitted. The display 46 is the same as the display 25 of the user terminal 20, description thereof will be omitted. Note that the bus 40 may be, for example, a mobile body that can autonomously travel. In this case, similarly to the movement sign 10, the processor 41 controls the bus 40 based on a command from the server 30.

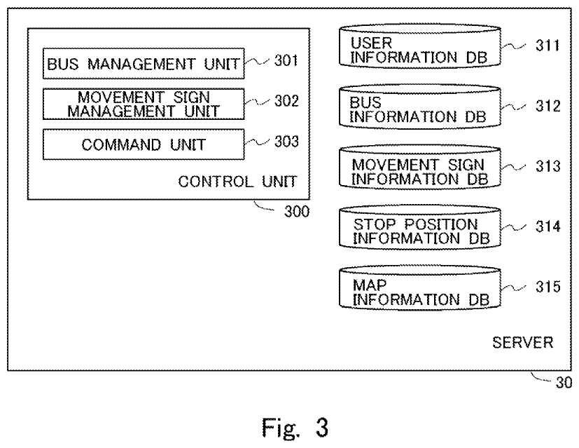

Next, the function of the server 30 will be described. FIG. 3 is a diagram illustrating a functional configuration of the server 30. The server includes, as functional components, a control unit 300, user information DB311, bus information DB312, movement sign information DB313, stop position information DB314, and map information DB315. The processor 31 of the server 30 executes the processing of the control unit 300 by the computer program on the main storage unit 32. However, any of the functional components or a part of the processing thereof may be executed by a hardware circuit. The control unit 300 includes a bus management unit 301, a movement sign management unit 302, and a command unit 303.

The user information DB311, the bus information DB312, the movement sign information DB313, the stop position information DB314, and the map information DB315 are constructed when a program of a database management system (DBMS) executed by the processor 31 manages information stored in the auxiliary storage unit 33. The user information DB311, the bus information DB312, the movement sign information DB313, the stop position information DB314, and the map information DB315 are, for example, relational databases.

Any of the functional components of the server 30 or a part of the processing thereof may be executed by another computer connected to the network N1.

The bus management unit 301 collects information related to the bus 40 and updates bus information DB312 described later. Specifically, the bus management unit 301 periodically communicates with the plurality of buses 40 and collects information on the current positions of the buses The collected information is reflected in bus information DB312 described later.

Further, the bus management unit 301 acquires a use request from a user who desires to use the bus. The use request is information transmitted from the user terminal 20 to the server 30. The use request includes information related to the user ID, the boarding point desired by the user, the boarding date and time desired by the user, the alighting point desired by the user, and the like. The use request may further include information on the number of people using the bus 40. The user ID is an identifier unique to the user. User information (for example, a name, an address, a telephone number, an e-mail address, and the like) corresponding to the user ID may be registered in advance by the user using the user terminal 20, or may be transmitted from the user terminal together with the use request. The user information is stored in the auxiliary storage unit 33 in association with the user ID. In addition, information related to the boarding point, the boarding date and time, the alighting point, and the like included in the use request is stored in the user information DB311.

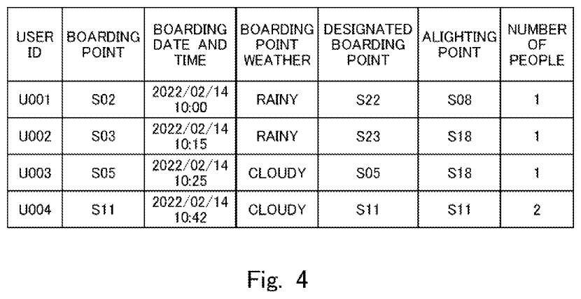

Here, FIG. 4 is a diagram illustrating a table configuration of the user information DB311. The user information DB311 includes fields of a user ID, a boarding point, a boarding date and time, a boarding point weather, a designated boarding point, an alighting point, and the number of people. In the user ID field, information (user ID) by which a user can be identified is input. The boarding point field stores information on a boarding point included in the use request. The boarding point is a point at which the user desires to board the bus 40, and is indicated by, for example, coordinates (latitude and longitude), an address, a name of a building, or a name or number of a bus stop. The boarding point may be, for example, the current location of the user terminal 20 or may be a point input by the user. In addition, when the user inputs a region in which the user desires to ride, a representative point of the region may be input.

Information related to the boarding date and time included in the use request is stored in the boarding date and time field. The boarding date and time is a date and time at which the user desires to board the bus 40. The boarding date and time may be input as a time period having a certain width. In the boarding point weather field, information on weather corresponding to the riding date and time of the boarding point is input. Upon receiving the use request, the bus management unit 301 acquires information related to weather from the weather forecast server 60. In this case, a weather forecast corresponding to the point input in the boarding point field may be acquired, or a weather forecast in a predetermined range including the point input in the boarding point field may be acquired. The predetermined range is a range that can be set as a stop of the bus 40, and is, for example, a range in which the user can move on foot.

The designated boarding point field is a boarding point designated by the command unit 303, which will be described later, and is a point where the bus 40 actually stops and the user rides. When a point desired by the user is set as the designated boarding point, the same information is input to the boarding point field and the designated boarding point field.

The alighting point field stores information on an alighting point included in the use request. The alighting point is a point at which the user desires to get off the bus 40, and is indicated by, for example, coordinates (latitude and longitude), an address, a name of a building, or a name or number of a bus stop. The boarding point, the designated boarding point, or the alighting point may be a point registered in advance in the auxiliary storage unit 33 of the server 30 as a point at which the bus 40 can stop. The number of persons field stores information on the number of persons included in the use request. This number of people is the number of people who wish to board the bus 40.

When the use request is received from the user terminal 20, the command unit 303 selects the bus 40 that can be dispatched based on the information such as the boarding point, the boarding date and time, the alighting point, and the number of people included in the use request. The bus 40 that can be dispatched is the bus 40 that has vacant seats corresponding to the number of people, can move to the boarding point on the boarding date and time, and can move to the alighting point thereafter. For example, the bus 40 that has a reservation for boarding or alighting at another point on the same date and time does not correspond to the movement sign 10 that can move to the boarding point on the boarding date and time. Therefore, the bus 40 may be selected according to the route of the bus 40 at the current time point.

When the weather corresponding to the boarding point of the user satisfies a predetermined condition, the command unit 303 changes the boarding point to a store or the like. The changed boarding point is input to the designated boarding point field. The predetermined condition is a condition of weather that may cause the user to feel uncomfortable. For example, the predetermined condition is satisfied when the weather includes rain, snow, wind having a wind speed equal to or higher than a predetermined value, heat equal to or higher than a first predetermined temperature, and cold equal to or lower than a second predetermined temperature. The predetermined condition may be set in advance by the user. For example, it may be set such that the predetermined condition is satisfied on a rainy or snowy day, but the predetermined condition is not satisfied even in a forecast in which a wind having a wind speed equal to or higher than a predetermined value blows. In addition, in the case of a forecast in which rain falls and wind having a wind speed equal to or higher than a predetermined value blows, the predetermined condition may be set to be satisfied. Further, the first predetermined temperature and the second predetermined temperature may be set by a user. The information set by the user is stored in the auxiliary storage unit 23 of the user terminal 20 or the auxiliary storage unit 33 of the server 30. The first predetermined temperature is an example of a first temperature, and the second predetermined temperature is an example of a second temperature.

In a case where the weather satisfies a predetermined condition, the command unit 303 selects a store that is a substitute for the boarding point desired by the user. This store is, for example, a store located within a predetermined distance from the boarding point desired by the user. The predetermined distance mentioned here is a distance that the user can move on foot. The predetermined distance may be set by a user. The position of the store is stored in stop position information DB314 described later.

For example, the command unit 303 searches for a store that has an equipment corresponding to the weather, is applicable to the available time zone, is within a predetermined range from the boarding point desired by the user, and designates the store as a new boarding point. When there are a plurality of stores within the predetermined range, the user may be caused to select a store to be used as a bus stop from the plurality of stores, or a store closest to boarding point desired by the user may be used as the bus stop.

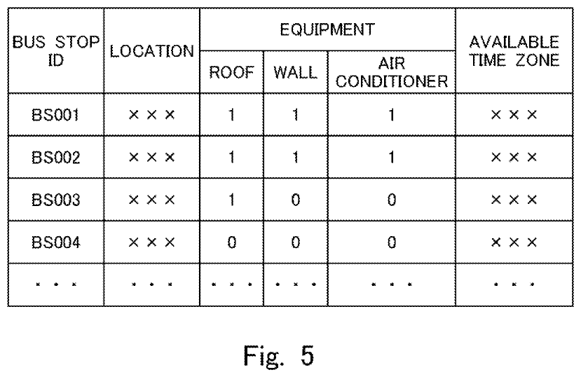

FIG. 5 is a diagram illustrating a table configuration of the stop position information DB314. The stop position information DB314 includes fields of a bus stop ID, a location, equipment, and an available time zone. In the bus stop ID field, information (bus stop ID) capable of identifying a bus stop of the bus 40 is input. The bus stop may be, for example, a point on a road or a point where a building such as a store is present. When the bus 40 stops at a parking lot of a store, the store may be set as a stop. In the equipment field, information on facilities provided at the bus stop is input. The equipment includes a roof, a wall, an air conditioner, and the like. The air conditioner is an example of a cooling equipment and a heating equipment. “1” is input when each equipment is provided, and “0” is inputted when each equipment is not provided. The “ROOF” is the equipment that prevents a user from being exposed to rain or snow. The “WALL” is the equipment that prevents the user from being exposed to the wind. The “AIR CONDITIONER” is the equipment capable of adjusting temperature. In the available time zone field, information on a time zone available as a bus stop is input. For example, since business hours are determined in a store, it may be available as a bus stop only within the business hours. In addition, when the available time zone varies depending on the day or the day of the week, such information is also input. In addition, for example, on regular holidays of the store, it may not be used as the bus stop.

When the bus 40 that can be dispatched is selected, the command unit 303 generates an operation command that is a command for operating the bus 40. The operation command includes, for example, a route of the bus 40. The command unit 303 generates a route based on the map information stored in the map information DB315. For example, the command unit 303 generates the operation command so that the bus 40 starts from the current location and travels via the designated boarding point and the alighting point of each user on the dispatch date and time.

The map information DB315 includes, for example, link information on roads (links), node information on nodes, intersection information on intersections, search information for searching for routes, store information on stores, search information for searching for points, and the like. In addition, information on a point at which the bus 40 and the movement sign 10 can stop may be stored.

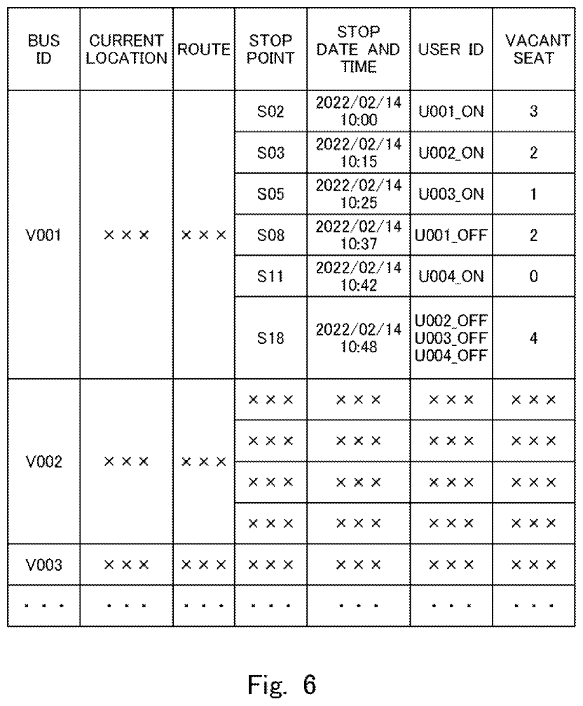

When the operation command of the bus 40 is generated, the command unit 303 updates the bus information DB312. Here, the configuration of the bus information stored in the bus information DB312 will be described based on FIG. 6. FIG. 6 is a diagram illustrating a table configuration of the bus information DB312. The bus information table includes fields of a bus ID, a current location, a route, a stop point, a stop date and time, a user ID, and a vacant seat. In the bus ID field, information (bus ID) capable of identifying the bus 40 is input. The bus ID is assigned to each bus 40 by, for example, the bus management unit 301. In the current location field, information (position information) on the current location of the bus 40 is input. The current position of the bus 40 is detected by the position information sensor 45 of the bus 40 and transmitted to the server 30. The current location field is updated each time location information is received from the bus 40.

Information about the route of the bus 40 is entered in the route field. In the stop point field, information on a point at which the bus 40 stops is input. In the stop point field, for example, information regarding a point that can be a destination of the bus 40, such as coordinates, an address, or a name of a building, is input. The point at which the bus 40 stops is a point at which a user gets on or off the bus 40, and is input based on information related to the designated boarding point or the alighting point of any user stored in the stop position information DB314.

The stop point column is arranged in the order in which the bus 40 stops. Information on the stop date and time of the bus 40 corresponding to the stop point is input to the stop date and time field. The date and time at which the user gets off at the alighting point may be calculated based on the getting-on time and the time required for the bus 40 to move from the boarding point to the alighting point. Since the time required for movement of the bus 40 can be calculated from past data, a movement distance, or the like, the date and time of arrival at the alighting point may be calculated based on this time.

In the user ID field, an identification symbol (user ID) unique to the user is input. After the user ID, a character string corresponding to boarding or alighting is added. When getting on the vehicle at the corresponding stop point, a character string of ON is added after the user ID, and when getting off the vehicle at the corresponding stop point, a character string of OFF is added after the user ID. In the vacant seat field, the number of vacant seats of the bus 40 when departing from the corresponding stop point is stored.

After selecting the bus 40 corresponding to the boarding point and the alighting point of the user, the command unit 303 further selects the movement sign 10 corresponding to the boarding point and the alighting point. Different movement sign 10 may be selected for the boarding point and the alighting point, or the same movement sign 10 may be selected. For example, one movement sign 10 may be assigned to each bus 40. In this case, the movement sign 10 may precede the bus 40 and travel the same route as the bus 40. However, the movement sign 10 is caused to arrive at the bus stop a predetermined time earlier than the bus 40. Therefore, the command unit 303 generates the operation command of the movement sign 10 so that the movement sign 10 arrives at the stop point of the bus 40 a predetermined time before the time at which the bus 40 arrives. The operation command includes a route, each stop position, an arrival time at the each stop position, a departure time from the each stop position, and the like. The generated operation command is transmitted to the corresponding movement sign 10. When a store is designated as a bus stop, the command unit 303 generates an operation command so that the movement sign 10 stops on a road in front of the store or in a parking lot of the store.

Further, one movement sign 10 may correspond to a plurality of buses 40. In this case, it may not correspond to all the stop positions of one bus 40 but may correspond to a part of the stop positions. For example, one or a plurality of movement sign 10 may be assigned to a predetermined area, and one or a plurality of movement sign 10 may be operated so as to correspond to the bus 40 stopping in the predetermined area. In this case, the command unit 303 selects a movement sign 10 that can arrive at the stop position of the bus 40 a predetermined time before the arrival of the bus 40 within a predetermined area, and generates an operation command including the route of the movement sign 10. The generated operation command is transmitted to the corresponding movement sign 10.

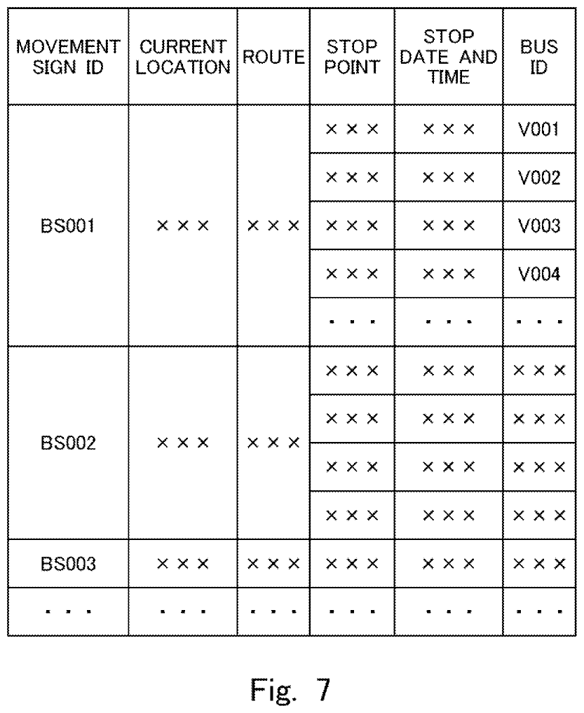

When the operation command of the movement sign 10 is generated, the command unit 303 updates the movement sign information DB313. Here, a configuration of the movement sign information stored in the movement sign information DB313 will be described based on FIG. 7. FIG. 7 is a diagram illustrating a table configuration of the movement sign information DB313. The movement sign information table includes fields of a movement sign ID, a current location, a route, a stop point, a stop date and time, and a bus ID. In the movement sign ID field, information (movement sign ID) capable of identifying the movement sign 10 is input. The movement sign ID is assigned to each movement sign 10 by, for example, the movement sign management unit 302. In the current location field, information (position information) on the current location of the movement sign 10 is input. The current position of the movement sign 10 is detected at predetermined time intervals by the position information sensor 15 of the movement sign 10 and transmitted to the server 30.

In the route field, information about the route of the movement sign 10 is entered. In the stop point field, information on a point at which the movement sign 10 stops is input. In the stop point field, for example, information regarding a point that can be a destination of the movement sign 10, such as coordinates, an address, or a name of a building, is input. The point at which the movement sign 10 stops is a point at which the user gets on or off the vehicle, and is the same as the stop point of the corresponding bus 40. The stop point columns are arranged in the order in which the movement sign 10 stop. Information related to the stop date and time of the movement sign 10 corresponding to the stop point is input to the stop date and time field. Information on the date and time of departure from the bus stop may also be input. In the bus ID field, a bus ID corresponding to the stop point is input.

When the movement sign 10 arrives at the stop position of the bus the command unit 303 generates a command for causing the display 18 of the movement sign 10 to display that the movement sign 10 is at a bus stop. A command is then generated to continue the display until the bus 40 arrives or until the time at which the movement sign 10 departs.

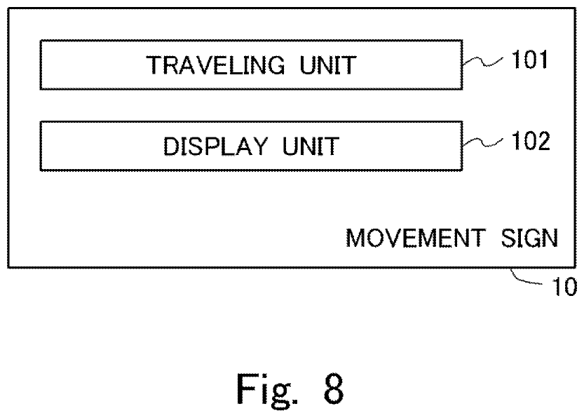

Next, the function of the movement sign 10 will be described. FIG. 8 is a diagram illustrating a functional configuration of the movement sign The movement sign 10 includes a traveling unit 101 and a display unit 102 as functional components. The processor 11 of the movement sign 10 executes processing of the traveling unit 101 and the display unit 102 by a computer program on the main storage unit 12. However, any of the functional components or a part of the processing thereof may be executed by a hardware circuit. Any one of the functional components of the movement sign 10 or a part of the processing thereof may be executed by another computer connected to the network N1.

The traveling unit 101 controls the traveling of the movement sign during the autonomous traveling of the movement sign 10. The traveling unit 101 generates a control command for controlling the driving unit 17 using the data detected by the environment information sensor 16. For example, the traveling unit 101 controls the rotation speed of the plurality of motors to control the speed of the movement sign 10 or to control the steering angle.

For example, the traveling unit 101 generates a traveling trajectory of the movement sign 10 based on data detected by the environment information sensor 16 and controls the driving unit 17 so that the movement sign 10 travels along the traveling trajectory. As a method of causing the movement sign 10 to autonomously travel, a known method can be employed. The traveling unit 101 may perform feedback control based on the detection value of the environment information sensor 16 during autonomous traveling. The traveling unit 101 autonomously travels to go around a predetermined route. This route is included in the operation command transmitted from the server 30. For example, the traveling unit 101 causes the movement sign 10 to travel based on the traveling route and the stop position included in the operation command received from the server 30. For example, the traveling unit 101 stores the operation command received from the server 30 in the auxiliary storage unit 13.

In addition, the traveling unit 101 periodically transmits information on the movement sign 10 to the server 30. For example, the traveling unit 101 transmits information on the current location acquired by the position information sensor 15 and the remaining capacity of the battery to the server 30 as the information on the movement sign 10.

Next, at the stop point of the bus 40, the display unit 102 executes a display process that is a process of displaying that it is the stop point of the bus 40 or the like. The display unit 102 executes the display process when both the condition related to the position of the movement sign 10 and the condition related to the time are satisfied. The display unit 102 compares the position information detected by the position information sensor 15 with the stop point included in the operation command transmitted from the server 30, and determines that the condition related to the position is satisfied when the current position of the movement sign is within a predetermined area from the stop point of the bus 40. In addition, display unit 102 compares the current time with the time at which bus 40 stops at the stop point received from server 30, and determines that the time-related condition is satisfied when the current time is within a predetermined time before the time at which bus 40 stops at the stop point.

When it is determined that the conditions of the time and the position are both satisfied, the display unit 102 causes the display 18 to display, for example, the name of the bus stop or the name of the bus 40 to be stopped. The display 18 may display information indicating a point at which the bus 40 stops and information indicating a time at which the bus arrives. As a result, who uses the bus 40 can recognize the location of the bus stop. This display is started a predetermined time before the scheduled arrival time of the bus 40 at the point where the bus 40 stops. The expected arrival time of the bus 40 corresponds to the stop date and time stored in the bus information DB312. Then, until the bus 40 arrives or until the movement sign 10 departs, it continues to display that the bus 40 is at a stop point.

When the bus 40 arrives, the traveling unit 101 moves the movement sign 10 toward the next destination.

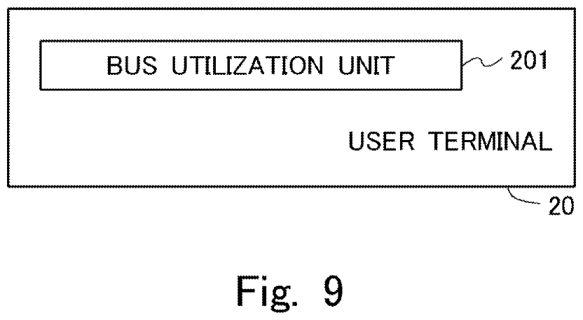

Next, functions of the user terminal 20 will be described. FIG. 9 is a diagram illustrating a functional configuration of the user terminal 20. The user terminal 20 includes a bus utilization unit 201 as a functional component. The processor 21 of the user terminal 20 executes the processing of the bus utilization unit 201 by a computer program on the main storage unit 22. However, a part of the processing of the bus utilization unit 201 may be executed by a hardware circuit. Note that a part of the processing of the bus utilization unit 201 may be executed by another computer connected to the network N1.

The bus utilization unit 201 has a function of accessing the server and interacting with the server 30. The function may be realized by a web browser operating on the user terminal 20 or dedicated application software. In the first embodiment, the bus utilization unit 201 is configured to be able to execute application software for interacting with the server The bus utilization unit 201 generates a utilization request in accordance with an input to the input unit 24 of the user terminal 20.

For example, the bus utilization unit 201 requests inputs of a boarding point desired by the user (hereinafter, also referred to as a desired boarding point), a boarding date and time desired by the user (hereinafter, also referred to as a desired boarding date and time), an alighting point desired by the user (hereinafter, also referred to as a desired alighting point), and the number of persons. In this case, the current position of the user terminal 20 may be set as the desired boarding point, and the current date and time may be set as the desired boarding date and time. A use request is generated based on these pieces of information. When a use request including information on the desired boarding point, the desired boarding date and time, and the desired alighting point is transmitted to the server 30, the server 30 selects a place where the bus 40 can stop around the desired boarding point and around the desired alighting point at the desired boarding date and time as a candidate of a stop position of the bus 40, and transmits the position to the user terminal 20. At this time, only the stop point corresponding to the bus 40 that can be reserved may be transmitted. Further, at this time, the server 30 selects a boarding point according to the weather forecast as a candidate. Then, the bus utilization unit 201 causes the display 25 to display a map, and causes the display 25 to display a point where the bus can stop on the map. When there are a plurality of points at which the bus 40 can stop, the plurality of points are displayed. The user selects a boarding point and an alighting point by tapping a point at which the bus displayed on the display 25 can stop.

When the boarding point and the alighting point are selected, the bus utilization unit 201 transmits information including the user ID, the boarding point, the boarding date and time, the alighting point, and the number of people to the server 30. Thereafter, for example, when information indicating that the reservation is completed is transmitted from the server 30, the bus utilization unit 201 causes the display 25 to display a screen indicating that the reservation is completed. Note that the reservation method is not limited to this, and other methods may be employed.

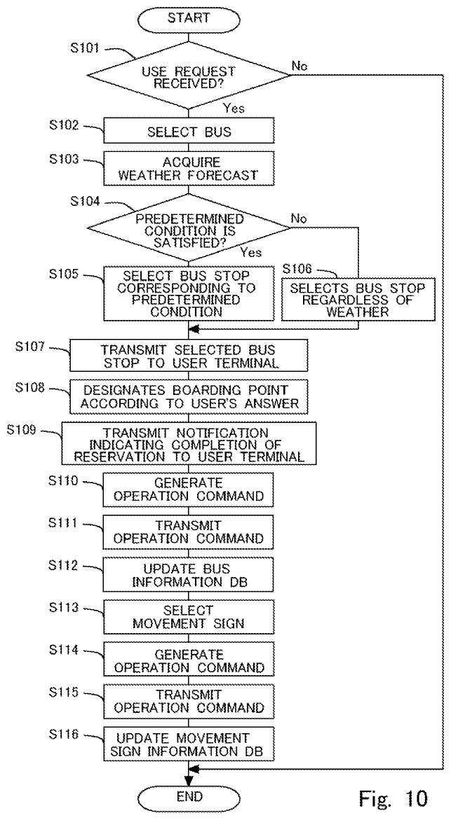

Next, a process of generating operation commands for the movement sign 10 and the bus 40 in the server 30 will be described. FIG. is a flowchart of a process of generating operation commands for the movement sign 10 and the bus 40 in the server 30 according to the first embodiment. The processing illustrated in FIG. 10 is executed at predetermined time intervals in the server 30.

In step S101, the bus management unit 301 determines whether or not a use request has been received from the user terminal 20. The information included in the use request is stored in the user information DB311. When an affirmative determination is made in step S101, the process proceeds to step S102, and when a negative determination is made, this routine is ended. In step S102, the command unit 303 selects the bus 40 on which the user is to ride. The command unit 303 selects the bus 40 based on the information included in the use request and the bus information stored in the bus information DB312. Specifically, the bus 40 that can move to the boarding point on the boarding date and time and then move to the alighting point and that has vacant seats corresponding to the number of persons is selected.

In step S103, the command unit 303 acquires a weather forecast from the weather forecast server 60. The weather forecast acquired at this time is a weather forecast corresponding to the information on the boarding date and time and the boarding point included in the use request. When acquiring the weather forecast, the command unit 303 stores information related to the weather forecast in the boarding point weather column of the record of the user ID corresponding to the user information DB311.

In step S104, the command unit 303 determines whether or not a predetermined weather-related condition is satisfied. For example, in the weather forecast, the command unit 303 determines that the predetermined condition is satisfied when there is a forecast of any one or more of rain, snow, wind having a wind speed equal to or higher than a predetermined value, heat equal to or higher than a first predetermined temperature, and cold equal to or lower than a second predetermined temperature. When an affirmative determination is made in step S104, the process proceeds to step S105, and when a negative determination is made, the process proceeds to step S106.

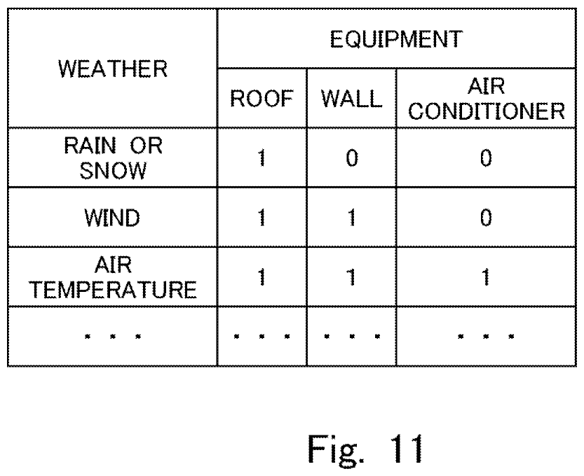

In step S105, the command unit 303 selects bus stops corresponding to a predetermined condition. The bus stop corresponding to the predetermined condition is a bus stop having an equipment corresponding to weather. The relationship between the weather and the equipment is stored in the auxiliary storage unit 33 of the server 30. FIG. 11 is a diagram illustrating a relationship between weather and equipment stored in the auxiliary storage unit 33. In FIG. 11, the row of “RAIN OR SNOW” indicates that rain or snow falls. The row of “WIND” indicates that wind having a wind speed equal to or higher than a predetermined value blows. The row of “AIR TEMPERATURE” indicates that the air temperature to or higher than the first predetermined value or equal to or lower than the second predetermined value. Further, the column of “ROOF” indicates whether or not a roof is necessary, “1” indicates that a roof is required, and “0” indicates that a roof is not necessarily required. In the event of rain or snow, at least the roof prevents the user from getting wet. In addition, the column of “WALL” indicates whether or not a wall is necessary, “1” indicates that a wall is required, and “0” indicates that a wall is not necessarily required. When a wind having a wind speed equal to or higher than a predetermined value blows, the user is not exposed to a strong wind if there are a roof and a wall that block the wind. Further, the column of “AIR CONDITIONER” indicates whether or not an air conditioner is required, “1” indicates that an air conditioner is required, and “0” indicates that an air conditioner is not necessarily required.

When the weather corresponding to the boarding point of the user satisfies a predetermined condition, the command unit 303 extracts necessary equipment based on the relationship illustrated in FIG. 11, compares the necessary equipment with the information related to the equipment stored in the stop position information DB314, and extracts the bus stop ID having the necessary equipment. At this time, for example, the bus stop ID of a bus stop located within a predetermined distance from the boarding point desired by the user or within a predetermined distance from the current location of the user is extracted. Further, the bus stop ID of the bus stop in which the boarding date and time of the user is in the available time zone is extracted from the bus stop ID. In this way, the command unit 303 selects a bus stop corresponding to a predetermined condition.

On the other hand, in step S106, the command unit 303 selects bus stops regardless of the weather. For example, the command unit 303 selects a bus stop within a predetermined range from the boarding point desired by the user. In this case, the bus stop to be selected may not include a store or may include a store.

In step S107, the command unit 303 transmits information related to the bus stops selected in step S105 or step S106 to the user terminal That is, in a case where there are a plurality of bus stops, information on the bus stop is transmitted to the user terminal 20 in order to cause the user to select a bus stop, or in a case where there is a single bus stop, information on the bus stop is transmitted to the user terminal 20 in order to confirm with the user whether or not the bus stop is appropriate. For example, the information about the store may include information about products sold at the store. The relationship between the store and the product may be stored in the auxiliary storage unit 33 or may be acquired from the store terminal 50. At this time, an instruction for displaying a screen for allowing the user to select a bus stop on the display 25 of the user terminal 20 may be included. For example, a map is displayed on the display 25 of the user terminal 20, and a command for displaying a bus stop on the map is generated and transmitted to the user terminal 20. This command includes a command for transmitting a response from the user to the server 30. The user selects a bus stop by tapping the bus stop on the map displayed on the user terminal 20. The bus utilization unit 201 of the user terminal 20 generates an answer based on the user's selection and transmits the answer to the server 30.

In step S108, the command unit 303 designates the boarding point of the bus 40 according to the user's answer received from the user terminal 20. Then, the user information DB311 is updated by inputting the bus stop selected by the user into the column of the designated boarding point of the user information DB311. In step S109, the command unit 303 transmits a notification indicating completion of reservation of the bus 40 to the user terminal 20. The notification includes an instruction to display an image indicating that the reservation is completed on the display 25 of the user terminal 20. In the user terminal 20 that has received this information, the bus utilization unit 201 causes the display 25 to display an image indicating that the reservation of the bus 40 has been completed.

In step S110, the command unit 303 generates an operation command so that the bus 40 starts from the current location and travels via the designated boarding point and the alighting point on the boarding date and time. At this time, a route of the bus 40 may be generated, and the route of the bus 40 may be included in the operation command. For example, the operation command may cause the display 46 of the bus 40 to display a screen for guiding the route of the bus 40.

Then, in step S111, the command unit 303 transmits the operation command to the bus 40. Further, in step S112, the command unit 303 updates the bus information DB312. The command unit 303 inputs a new route in the route field of the corresponding bus 40 and updates the fields of the stop point, the stop date and time, the user ID, and the vacant seat. At this time, if necessary, the records are replaced so that the stop points are arranged in the stop order on the route of the bus 40.

In step S113, the command unit 303 selects the movement sign 10 to be dispatched to the stop point of the bus 40. For example, the command unit 303 selects the movement sign 10 based on the bus information stored in the bus information DB312. Specifically, the movement sign 10 capable of moving to the newly added designated boarding point or alighting point is selected. Different movement sign 10 may correspond to the designated boarding point and the alighting point. For example, the command unit 303 selects the movement sign 10 that can arrive at the newly added designated boarding point a predetermined time before the riding date and time. At this time, the movement sign 10 is selected based on the route, the stop point, and the stop date and time stored in the movement sign information DB313. For example, the movement sign 10 may be selected on condition that there is a newly added boarding point within a predetermined distance from the current route of the movement sign 10. The predetermined distance may be determined based on the cost, for example. The same applies to the alighting point. When one movement sign 10 is assigned to each bus 40, the already assigned movement sign 10 is selected.

For example, the command unit 303 may regenerate the routes of the plurality of movement sign 10 so that the sum of the moving distances of the plurality of movement sign 10 is the shortest. That is, when a stop point of the bus 40 is newly added, there may be a case where the moving distance as a whole becomes shorter by changing the route of a plurality of movement sign 10 than by changing the route of one movement sign 10. In this case, the routes of the plurality of movement sign 10 may be changed.

In step S114, the command unit 303 generates an operation command so that the movement sign 10 departs from the current location and arrives at the stop point before the predetermined time on the day and time of the bus 40 and displays on the display 25 that it is the bus stop. The operation command includes a route of the movement sign 10. When the route of a plurality of movement sign 10 is changed, an operation command corresponding to each movement sign 10 is generated.

In step S115, the command unit 303 transmits the operation command to the movement sign 10. Further, in step S116, the command unit 303 updates the movement sign information DB313. That is, a new route is input to the route field of the corresponding movement sign 10, and the stop point, the stop date and time, and the bus ID are updated. At this time, if necessary, the records are replaced so that the stop points are arranged in the stop order on the route of the movement sign 10.

As described above, according to the first embodiment, when the weather at the boarding point desired by the user is such that the user feels uncomfortable, the user can be prevented from feeling uncomfortable by designating the stop of the bus 40 at a position that is hardly affected by the weather. In addition, since the user can be guided to a store or the like, it is possible for the store to increase sales.

### Second Embodiment

In the first embodiment, the server 30 selects a plurality of bus stops and causes the user to select a bus stop from among the bus stops.

On the other hand, in the second embodiment, the command unit 303 designates the bus stop closest to the current location of the user according to the weather, for example.

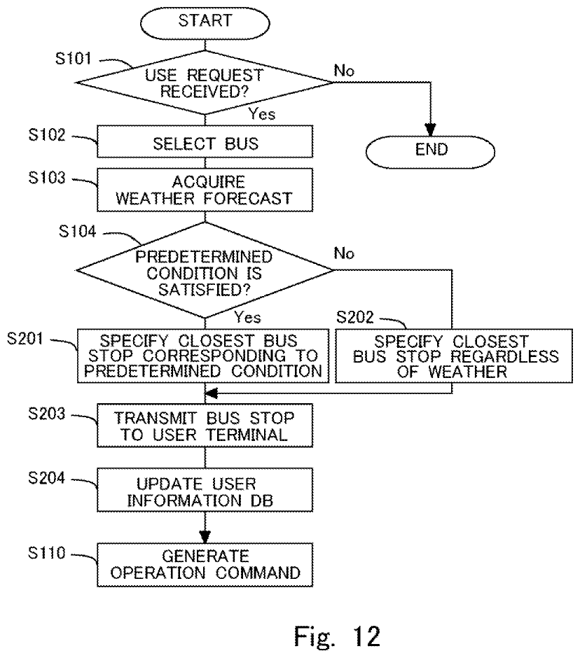

Next, a process of generating operation commands for the movement sign 10 and the bus 40 in the server 30 will be described. FIG. 12 is a flowchart of a process of generating operation commands for the movement sign 10 and the bus 40 in the server 30 according to the second embodiment. The processing illustrated in FIG. 12 is executed at predetermined time intervals in the server 30. Note that steps in which the same processes as those in the flowchart illustrated in FIG. 10 are performed are denoted by the same reference numerals, and description thereof is omitted. Since the processing after step S110 is the same as that of the flowchart illustrated in FIG. 10, illustration and description thereof will be omitted.

In the flowchart illustrated in FIG. 12, when an affirmative determination is made in step S104, the process proceeds to step S201. In step S201, the command unit 303 specifies the bus stop closest to the boarding point desired by the user among the bus stop corresponding to the predetermined condition. The bus stops corresponding to the predetermined conditions are selected in the same manner as in step S105. The bus stop ID of a bus stop in which the boarding date and time of the user is in the available time zone is extracted from the bus stops. Further, the bus stop ID of the bus stop closest to the boarding point desired by the user is extracted from the bus stop ID. In this way, the command unit 303 specifies the bus stop that corresponds to the predetermined condition and is closest to the boarding point desired by the user.

On the other hand, in the flowchart illustrated in FIG. 12, when a negative determination is made in step S104, the process proceeds to step S202. In step S202, the command unit 303 specifies the bus stop closest to the boarding point desired by the user regardless of the weather.

Next, in step S203, the command unit 303 transmits information on the bus stops designated in step S201 or step S202 to the user terminal 20. Here, in order to notify the user of the designated bus stop, information related to the bus stop is transmitted. The information transmitted to the user terminal 20 includes the position information of the bus stop or a command for displaying a map on the display 25 of the user terminal 20 and displaying the bus stop on the map. In the user terminal that has received this information, the bus utilization unit 201 causes the display 25 to display a screen relating to the bus stop.

In step S204, the command unit 303 updates the user information DB311 according to the designated bus stop. That is, the bus stop designated by the command unit 303 is input to the column of the designated boarding point of the user information DB311.

As described above, in the present embodiment, since the server designates a bus stop, the user does not need to select a bus stop.

### Third Embodiment

In the third embodiment, when a store is designated as a bus stop, a coupon usable in the store is issued to the user terminal 20. When the server 30 designates a store as a bus stop, a charge is collected from the store as an advertising fee. Note that a plurality of stores may be presented to the user, and the user may select a store to be a bus stop from among the plurality of stores.

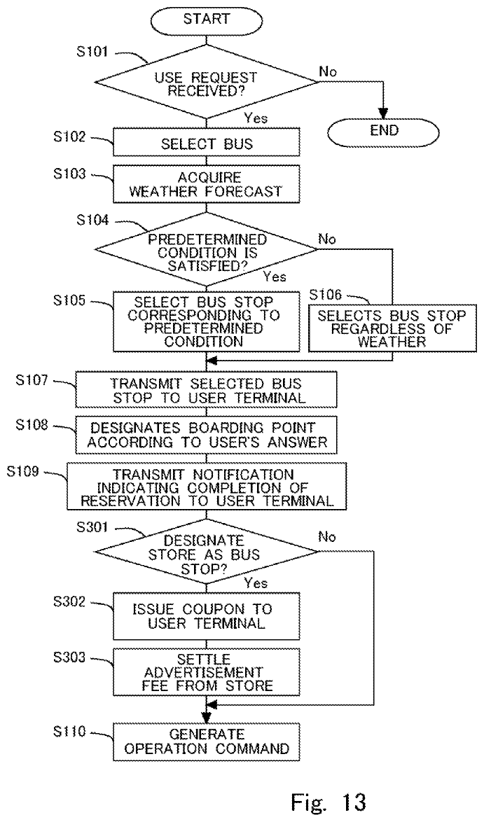

Next, a process of generating operation commands for the movement sign 10 and the bus 40 in the server 30 will be described. FIG. 13 is a flowchart of a process of generating operation commands for the movement sign 10 and the bus 40 in the server 30 according to the third embodiment. The processing illustrated in FIG. 13 is executed at predetermined time intervals in the server 30. Note that steps in which the same processes as those in the flowchart illustrated in FIG. 10 are performed are denoted by the same reference numerals, and description thereof is omitted. Since the processing after step S110 is the same as that of the flowchart illustrated in FIG. 10, illustration and description thereof will be omitted.

In the flowchart illustrated in FIG. 13, when the process of step S109 is completed, the process proceeds to step S301. In step S301, the command unit 303 determines whether or not the boarding point designated in step S108 is a store. In this step S301, it is determined whether or not it is necessary to provide a coupon to the user and to collect an advertising fee from the store. When an affirmative determination is made in step S301, the process proceeds to step S302, and when a negative determination is made, the process proceeds to step S110.

In step S302, the command unit 303 issues a coupon to the user terminal 20. At this time, a coupon associated with the store serving as the designated boarding point is issued. As a result, for example, the image of the coupon can be displayed on the display 25 of the user terminal 20. The information related to the coupon is stored in the auxiliary storage unit 23 of the user terminal 20, for example, and can be displayed on the display 25 at any time by the user performing a predetermined input. In addition, information related to a coupon associated with a store is stored in the stop position information DB314.

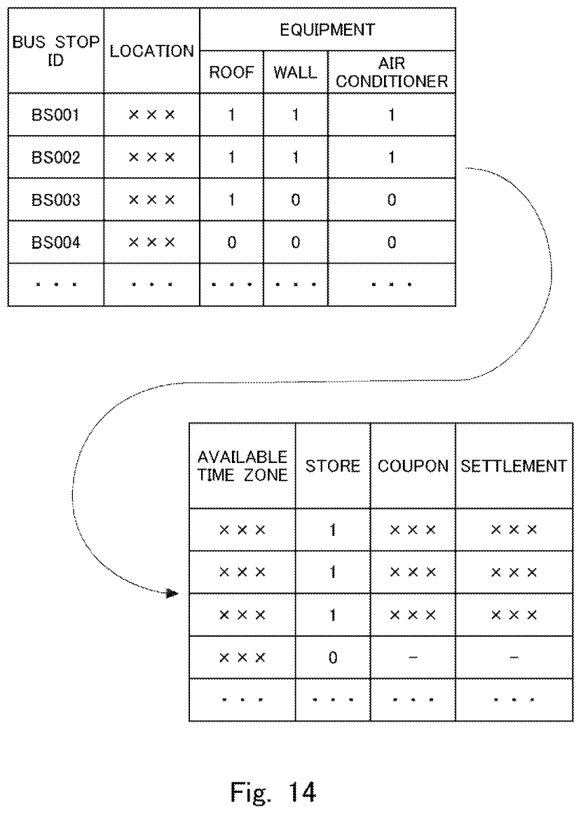

FIG. 14 is a diagram illustrating a table configuration of the stop position information DB314 according to the third embodiment. The stop position information DB314 includes fields of bus stop ID, location, equipment, available time zone, store, coupon, and settlement. Since the respective fields of the bus stop ID, the location, the equipment, and the available time zone are the same as those in FIG. 5, description thereof will be omitted. In the store field, information capable of determining whether or not the bus stop is a store is input. In the example illustrated in FIG. 14, when the stop is a store, “1” is input to the store field, and when the stop is not a store, “0” is input to the store field.

In the coupon field, information on a coupon to be provided to the user is input. Examples of the coupon provided to the user include a coupon that can be used as cash in a store, a coupon that can receive a predetermined discount, a coupon that can give a predetermined bonus, a coupon that can give predetermined points, and a coupon that increases the rate of giving points. In addition, the coupon may be used not only for purchasing a product but also for providing a service. In addition, information beneficial to the user may be input to the coupon field. The information input to the coupon field is transmitted from the store terminal 50 by an employee of the store.

In the settlement field, when a store is designated as a bus stop, information relating to settlement when a charge is collected as an advertising fee from the store is input. For example, information relating to the payment of the charge, such as a bank account for debiting the charge or a credit card number, is input. Alternatively, information about the destination of the bill may be input. The information input to the settlement field is transmitted from the store terminal 50 by an employee of the store.

Referring back to FIG. 13, in step S303, the command unit 303 executes a process of settling the advertisement fee from the store. For example, a process of debiting a fee as an advertising fee from a bank account input to the stop position information DB314 is executed.

As described above, according to the present embodiment, the user can use the store as a bus stop in the weather where the user feels uncomfortable, such as on a rainy day, and further can obtain a coupon usable in the store, so that the user can purchase a product at a low price. In addition, since more people come to the store, profits can be increased. For companies or municipalities that operate buses, it is possible to increase the number of bus users on bad weather days and to obtain advertising fees from stores.

### Fourth Embodiment

In the fourth embodiment, an inquiry is made to a user as to whether or not to select a bus stop in accordance with weather, and a bus stop is selected in accordance with a response from the user. For example, there may be a user who prefers a nearby bus stop without a roof even on a rainy day. Therefore, the user is asked which to choose.

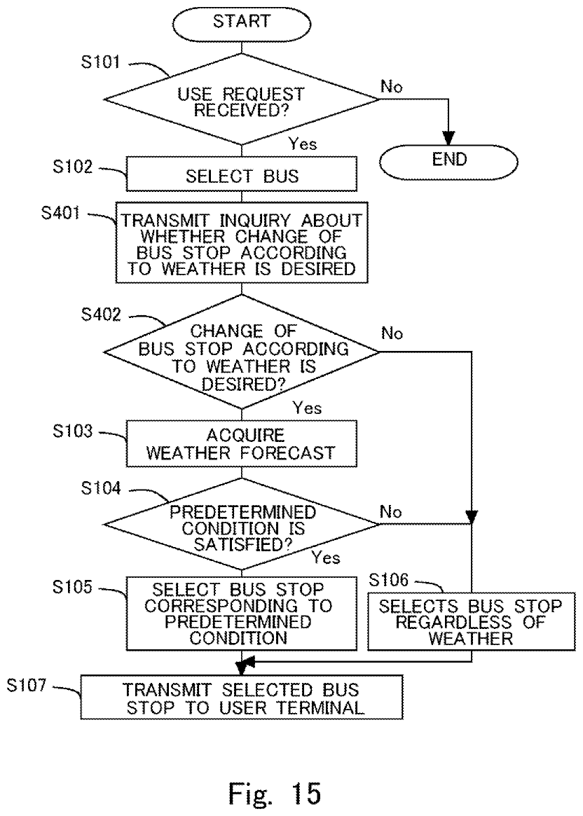

Next, a process of generating operation commands for the movement sign 10 and the bus 40 in the server 30 will be described. FIG. 15 is a flowchart of a process of generating operation commands for the movement sign 10 and the bus 40 in the server 30 according to the fourth embodiment. The processing illustrated in FIG. 15 is executed at predetermined time intervals in the server 30. Note that steps in which the same processes as those in the flowchart illustrated in FIG. 10 are performed are denoted by the same reference numerals, and description thereof is omitted. Since the processing after step S107 is the same as that of the flowchart illustrated in FIG. 10, illustration and description thereof will be omitted.

In the flowchart illustrated in FIG. 15, when the process of step S102 is completed, the process proceeds to step S401. In step S401, the command unit 303 transmits to the user terminal 20 a query as to whether or not a weather-based change in bus stops is desired. At this time, a command may be transmitted to cause the display 25 of the user terminal to display an inquiry about whether or not the user desires to change the bus stop in accordance with the weather. The user inputs an answer to the user terminal 20 by a predetermined method, and the bus utilization unit 201 of the user terminal 20 transmits the answer to the server 30.

In step S402, the command unit 303 determines whether or not the response received from the user terminal 20 indicates a request to change the bus stops according to the weather. When an affirmative determination is made in step S402, the process proceeds to step S103, and when a negative determination is made, the process proceeds to step S106.

As described above, according to the present embodiment, the user can select whether or not to use the store as a bus stop in the weather where the user feels uncomfortable, such as on a rainy day, thereby improving the convenience of the user. For example, it is possible to prevent a distant store from being designated as a bus stop on a rainy day even though the user does not desire it.

### Fifth Embodiment

In the fourth embodiment, before selecting a bus stop, the user is asked whether or not to select a bus stop according to the weather. On the other hand, in the fifth embodiment, when the distance to the bus stop selected in accordance with the weather is longer than the distance to the bus stop selected regardless of the weather, an inquiry is made to the user as to whether or not to designate the bus stop in accordance with the weather, and the bus stop is designated in accordance with the answer from the user.

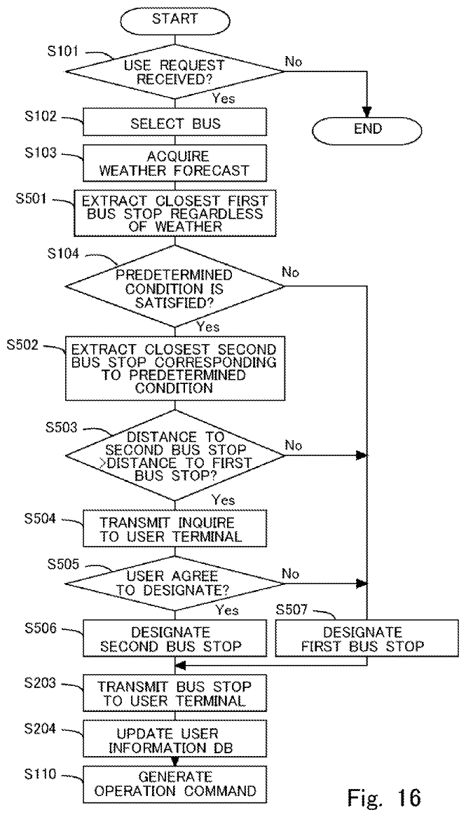

Next, a process of generating operation commands for the movement sign 10 and the bus 40 in the server 30 will be described. FIG. 16 is a flowchart of a process of generating operation commands for the movement sign 10 and the bus 40 in the server 30 according to the fifth embodiment. The processing illustrated in FIG. 16 is executed at predetermined time intervals in the server 30. Note that steps in which the same processes as those in the flowchart illustrated in FIG. 10 or FIG. 12 are performed are denoted by the same reference numerals, and description thereof is omitted. Since the processing after step S110 is the same as that of the flowchart illustrated in FIG. 10, illustration and description thereof will be omitted.

In the flowchart illustrated in FIG. 16, when the process of step S103 is completed, the process proceeds to step S501. In step S501, the command unit 303 extracts a bus stop (hereinafter, also referred to as a first bus stop) closest to the boarding point desired by the user regardless of the weather. The command unit 303 extracts the first bus stop in the same manner as in step S202.

Next, in step S104, the command unit 303 determines whether or not a predetermined weather-related condition is satisfied. When an affirmative determination is made in step S104, the process proceeds to step S502, and when a negative determination is made, the process proceeds to step S507.

In step S502, the command unit 303 extracts a bus stop (hereinafter also referred to as a second bus stop) closest to the boarding point desired by the user among the bus stop corresponding to the predetermined condition. The command unit 303 extracts the second bus stop in the same manner as step S201. In step S503, the command unit 303 determines whether or not the distance to the second bus stop is longer than the distance to the first bus stop. The distance from the boarding point desired by the user or the distance from the current location of the user terminal 20 is compared.

Alternatively, it may be determined whether or not the difference between the distance to the second bus stop and the distance to the first bus stop is equal to or greater than a predetermined distance. The predetermined distance may be settable in advance by the user. In other words, the user may be able to set how long the movement distance may be. Further, the predetermined distance may be set by the server 30. The predetermined distance in this case is set as a distance at which the user does not feel inconvenience.

When an affirmative determination is made in step S503, the process proceeds to step S504, and when a negative determination is made, the process proceeds to step S507.

In step S504, the command unit 303 transmits information to the user terminal 20 for inquiring the user whether or not the second bus stop can be specified, although the distance to the second bus stop is longer than the distance to the first bus stop. The information transmitted at this time includes an instruction to display the inquiry on the display 25 of the user terminal 20. In the user terminal 20 that has received this information, the bus utilization unit 201 displays the inquiry on the display 25.

In step S505, the command unit 303 determines whether or not the response received from the user terminal 20 agrees to designate the second bus stop. When an affirmative determination is made in step S505, the process proceeds to step S506, and when a negative determination is made, the process proceeds to step S507.

Then, in step S506, the command unit 303 designates the second bus stop, while in step S507, the command unit 303 designates the first bus stop.

As described above, according to the present embodiment, it is possible to improve the convenience of the user by inquiring of the user whether or not the moving distance of the user may be increased before designating the store as the bus stop in the weather where the user feels uncomfortable, such as on a rainy day. For example, it is possible to prevent a distant store from being designated as a bus stop on a rainy day even though the user does not desire it.

### OTHER EMBODIMENTS

The above-described embodiment and modification are merely examples, but the present disclosure can be implemented with appropriate modifications without departing from the spirit thereof.

The processing and/or means (devices, units, parts, etc.) described in the present disclosure can be freely combined and implemented as long as no technical contradiction occurs.

In addition, the processing described as being performed by a single device or unit may be shared and performed by a plurality of devices or units. Alternatively, the processing described as being performed by different devices or units may be performed by one device or unit. In a computer system, a hardware configuration (server configuration) for realizing each function thereof can be changed in a flexible manner. For example, the movement sign 10 may include a part of the functions of the server 30.

The present disclosure can also be realized by supplying to a computer a computer program in which the functions described in the above-described embodiment or modification are implemented, and reading out and executing the program by means of one or more processors included in the computer. Such a computer program may be provided to the computer by a non-transitory computer readable storage medium that can be connected to a system bus of the computer, or may be provided to the computer via a network. The non-transitory computer readable storage medium includes, for example, any type of disk such as a magnetic disk (e.g., a floppy (registered trademark) disk, a hard disk drive (HDD), etc.), an optical disk (e.g., a CD-ROM, a DVD disk, a Blu-ray disk, etc.) or the like, a read-only memory (ROM), a random-access memory (RAM), an EPROM, an EEPROM, a magnetic card, a flash memory, an optical card, or any type of medium suitable for storing electronic commands or instructions.

What is claimed is:

1. An information processing apparatus comprising a controller configured to designate a first position where a shielding object is present as a boarding point of a bus in response to a weather forecast at a boarding date and time of a user on the bus being predetermined weather.

2. The information processing apparatus according to claim 1, wherein when the predetermined weather is rain or snow, the controller designates a position where a roof is present as the first position.

3. The information processing apparatus according to claim 1, wherein when the predetermined weather includes a wind blowing at a wind speed equal to or higher than a predetermined value, the controller designates a position where a wall is present as the first position.

4. The information processing apparatus according to claim 1, wherein when the predetermined weather includes a temperature equal to or higher than a first temperature, the controller designates a position where a cooling equipment is located as the first position.

5. The information processing apparatus according to claim 1, wherein when the predetermined weather includes a temperature equal to or lower than a second temperature, the controller designates a position where heating equipment is located as the first position.

6. The information processing apparatus according to claim 1, wherein the controller designates a location of a store as the first position.

7. The information processing apparatus according to claim 6, wherein before designating the location of the store as the first position, the controller presents a plurality of stores to the user who makes a reservation, and designates the location of the store selected by the user as the first position.

8. The information processing apparatus according to claim 6, wherein the controller receives payment of a fee from the store when the location of the store is designated as the first position.

9. The information processing apparatus according to claim 6, wherein in a case where the location of the store is designated as the first position, the controller transmits information relating to a discount of a charge at the store to a terminal of the user making a reservation.

10. The information processing apparatus according to claim 1, wherein before designating the first position as the boarding point of the bus, the controller inquires of the user who makes a reservation about whether or not to change the boarding point of the bus.

11. The information processing apparatus according to claim 1, further comprising a memory configured to store information related to the first position.

12. An information processing method for causing a computer to designate a first position where a shielding object is present as a boarding point of a bus in response to a weather forecast at a boarding date and time of a user on the bus being predetermined weather.

13. The information processing method according to claim 12, wherein when the predetermined weather is rain or snow, the computer designates a position where a roof is present as the first position.

14. The information processing method according to claim 12, wherein when the predetermined weather includes a wind blowing at a wind speed equal to or higher than a predetermined value, the computer designates a position where a wall is present as the first position.

15. The information processing method according to claim 12, wherein when the predetermined weather includes a temperature equal to or higher than a first temperature, the computer designates a position where a cooling equipment is located as the first position.

16. The information processing method according to claim 12, wherein when the predetermined weather includes a temperature equal to or lower than a second temperature, the computer designates a position where heating equipment is located as the first position.

17. The information processing method according to claim 12, wherein the computer designates a location of a store as the first position.

18. The information processing method according to claim 17, wherein before designating the location of the store as the first position, the computer presents a plurality of stores to the user who makes a reservation, and designates the location of the store selected by the user as the first position.

19. The information processing method according to claim 17, wherein the computer receives payment of a fee from the store when the location of the store is designated as the first position.

20. A non-transitory storage medium storing a program configured to cause a computer to designate a first position where a shielding object is present as a boarding point of a bus in response to a weather forecast at a boarding date and time of a user on the bus being predetermined weather.
